(19) United States
(12) Patent Application Publication
(10) Pub. No.: US 2015/0153585 A1
(43) Pub. Date: Jun. 4, 2015

(54) CAMERA STABILIZATION PLATFORM SYSTEM

(71) Applicant: Howard SMITH, Cheshire (GB)

(72) Inventor: Howard SMITH, Cheshire (GB)

(21) Appl. No.: 14/619,408

(22) Filed: Feb. 11, 2015

Related U.S. Application Data
(63) Continuation of application No. 14/123,600, filed on May 14, 2014, now abandoned.

(30) Foreign Application Priority Data
Jun. 3, 2011 (GB) 1109350.7

(51) Int. Cl. G02B 27/64

(52) U.S. Cl. CPC G02B 27/646

(57) ABSTRACT

There is provided a camera stabilization platform system comprising a body, a rotation sensor system in a fixed orientation relative to the body, a motor system and a rotatable member system operable to be rotated by the motor system relative to the body, the rotation sensor system operable to measure a rotation angle and a rotation direction, wherein the motor system is configured to rotate the rotatable member system by the sensed rotation angle in a rotation direction opposite to the sensed rotation direction.

### CROSS-REFERENCE TO RELATED APPLICATIONS

This application is a continuation of U.S. application Ser. No. 14/123,600, filed on May 14, 2014, which claims the priority of PCT/GB2012/051238, filed on Jun. 1, 2012, which claims priority to Great Britain Application No. 1109350.7, filed on Jun. 3, 2011, the entire contents of each of which is fully incorporated herein by reference.

### BACKGROUND OF THE INVENTION

1. Field of the Invention

The field of the invention relates to camera stabilization platform systems.

2. Technical Background

Camera stabilization systems such as WO02081962A1 are known. However, it is desirable to provide a camera stabilization platform system that may stabilize with respect to rotation around an axis. It is also desirable to provide such a system which has a fast response time, which is handheld, lightweight, with a small form factor, and which is modular.

In the film industry there is a need for camera systems which are stabilized with respect to rotation, which are portable and can be carried round a film set by a camera operator.

3. Discussion of Related Art

In WO02081962A1 there is disclosed a support apparatus for a body-mountable camera, comprising a camera mounting means comprising a battery mounting means for mounting at least one battery, and wherein the battery mounting means and the camera mounting means are movable relative to each other. Thus, there is provided a support apparatus in which the batteries may act as a counter-balance to the camera, or vice versa. There is also provided a method of stabilising a body-mountable camera using the apparatus disclosed therein.

WO09133353A2 discloses camera control systems. U.S. Pat. No. 7,261,476(B2) discloses a multi-component assembly mounting system. EP1497586(B1) discloses article mounting. US2005/167558A1, which is the closest known prior art, discloses an arrangement for eccentrically mounting a camera on a support incorporating two portions adapted for relative rotation about an axis defined by the orientation of the support to maintain a given camera orientation.

### SUMMARY OF THE INVENTION

According to an aspect of the invention there is provided a camera stabilization platform system comprising a body, a rotation sensor system in a fixed orientation relative to the body, a motor system and a rotatable member system operable to be rotated by the motor system relative to the body, the rotation sensor system operable to measure a rotation angle and a rotation direction, wherein the motor system is configured to rotate the rotatable member system by the sensed rotation angle in a rotation direction opposite to the sensed rotation direction.

The camera stabilization platform system may be one wherein the rotation sensor system is attached directly to the body.

The camera stabilization platform system may be one wherein the rotation sensor system and the body are attached to a rigid system.

The camera stabilization platform system may be one wherein the camera stabilization platform system weighs less than 3 kg.

The camera stabilization platform system may be one wherein the camera stabilization platform system weighs less than 1 kg.

The camera stabilization platform system may be one wherein the camera stabilization platform system is capable of being handheld.

The camera stabilization platform system may be one wherein the rotatable member system includes two rings.

The camera stabilization platform system may be one wherein the motor system comprises two motors, each motor driving a respective ring.

The camera stabilization platform system may be one wherein the camera stabilization platform system is operable to receive a camera between the two rings.

The camera stabilization platform system may be one wherein the camera stabilization platform system has a response time less than 20 ms.

The camera stabilization platform system may be one wherein the response time is less than 10 ms.

The camera stabilization platform system may be one wherein the response time is less than 5 ms.

The camera stabilization platform system may be one wherein the response time is less than 1 ms.

The camera stabilization platform system may be one wherein the rotatable member system is operable to perform a full 360 degree rotation relative to the body in less than 1 second.

The camera stabilization platform system may be one wherein the camera stabilization platform system is modular.

The camera stabilization platform system may be one wherein the camera stabilization platform system has a form factor of less than 12 inches.

The camera stabilization platform system may be one wherein the camera stabilization platform system includes a single electronics module making the camera stabilization platform system stand alone, with a single power input to the single electronics module.

The camera stabilization platform system may be one wherein the rotatable member system has a rotational axis, wherein it is possible to mount a camera completely nodally on the rotational axis.

### BRIEF DESCRIPTION OF THE DRAWINGS

FIG. 1 shows an example of part of a camera stabilization platform system.

FIG. 2 shows an example of an electronics module.

FIG. 3 shows an example of an electronics module.

FIG. 4 shows an example of a camera stabilization platform system, with a camera 4 in position between the two rings 1, 2.

FIG. 5 shows an example of a camera stabilization platform system, with a camera 4 in position between the two rings 1, 2.

FIG. 6 shows an example of a camera stabilization platform system.

FIG. 7 shows an example of part of a camera stabilization platform system.

FIG. 8 shows an example of a camera stabilization platform system.

FIG. 9 shows an example of a camera stabilization platform system.

FIG. 10 shows an example of a camera stabilization platform system.

FIG. 11 shows an example of part of a camera stabilization platform system, with a camera 4 in position between the two rings 1, 2.

FIG. 12 shows an example of a camera stabilization platform system, with a camera 4 in position between the two rings, in which one ring is obscuring the other ring.

### DETAILED DESCRIPTION

There now follows a description, which includes examples of the invention.

There is provided a camera stabilization platform system comprising a body, a rotation sensor system in a fixed orientation relative to the body, a motor system and a rotatable member system operable to be rotated by the motor system relative to the body, the rotation sensor system operable to measure a rotation angle and a rotation direction, wherein the motor system is configured to rotate the rotatable member system by the sensed rotation angle in a rotation direction opposite to the sensed rotation direction. The camera stabilization platform system is operable to receive a camera. The camera stabilization platform system may cause a camera mounted on the rotatable member system of the camera stabilization platform system not to rotate relative to an inertial frame of reference, such as a film studio, to a good approximation, when the body rotates.

The rotation sensor system may use one or more rotation sensors, alone or in combination, such as a three axis accelerometer, a two axis accelerometer, a magnetometer, a compass, or a gyroscope. Examples of gyroscopes include a gyrostat, a MEMS gyroscope, a fiber optic gyroscope, a vibrating structure gyroscope, and a dynamically tuned gyroscope. This would be clear to one skilled in the art.

In an example of the camera stabilization platform system, the rotation sensor system is attached directly to the body.

In an example of the camera stabilization platform system, the rotation sensor system and the body are attached to a rigid system such as to the main body of a motorbike.

In an example of the camera stabilization platform system, the rotatable member system is operable to perform a full 360 degree rotation in less than 1 second.

The AR-C is a fully stand alone, modular, lightweight horizontal camera stabilization platform. This unique lightweight platform is unlike anything else currently available in the world. In an example, it weighs less than 3 kg. In an example, it weighs less than 1 kg. In an example, it is handheld. In an example, it is portable.

The AR-C (Auto-levelling Revolution—Compact) has a small form factor of less then 12″ but can still accommodate all major cameras both film and Digital/HD. This unique lightweight and modular design allows the user to mount to a vast amount of platforms from remote heads and static heads, easy rig type systems to even hand held.

In fact any application where a camera is normally used, the AR-C can take care of the horizon, dramatically improving the overall image.

When mounted to a (remote) heads tilt axis the AR-C effectively gives two axes of movement—both tilt and roll. And it may be used like this with the new MK-V Fusion and Omega systems.

In an example, AR-C does not measure any aspects of the motion of the inner, rotatable ring. The AR-C sensors are totally separate from the inner ring and mounted against the sled. So it is the movement of the sensor box (usually fixed to the sled, and never fixed to the inner ring) that are being measured and hence compensated for.

In an example, the AR-C sensors do not measure roll-rate at all. Instead, they measure the static tilt angle—the angle with respect to the vertical gravitational field.

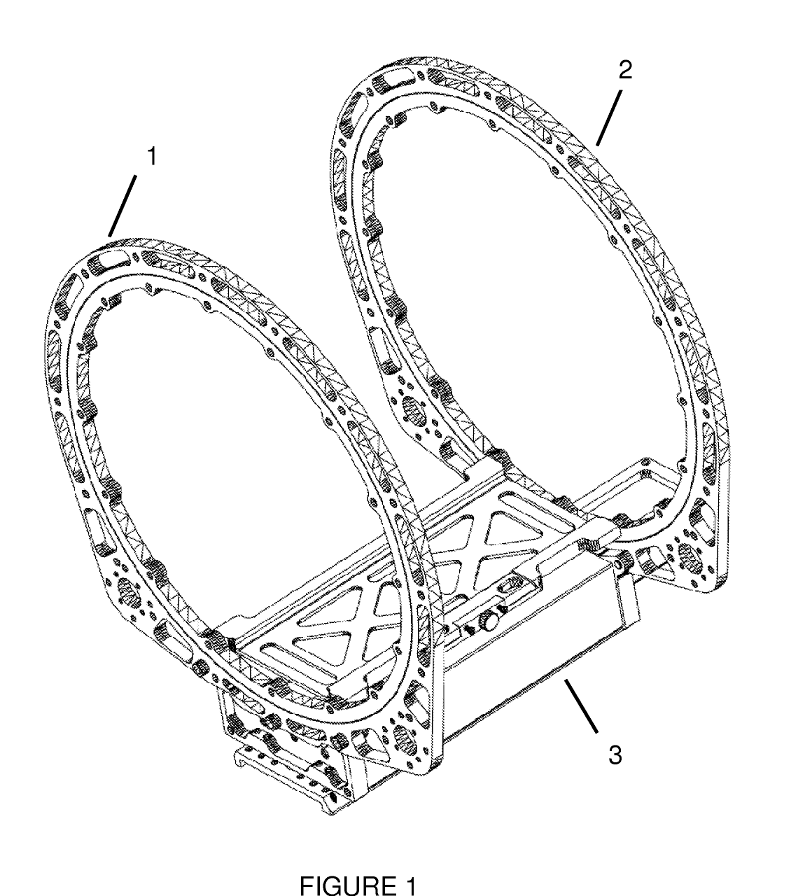

FIG. 1 shows an example of the AR-C. It includes two Lightweight and modular rings 1, 2 that allow easy access to all modern cameras both film and digital. This is the perfect solution to lightweight cranes and heads as with the parallax once the just the horizon is stabilized the shot looks so much better. (As pan and tilt are not so noticeable as if there is nothing in foreground it is hard to show the movement). In this example, the body of the camera stabilization platform system includes a frame relative to which the rings can rotate.

The AR-C can also be used with Motion control systems, as the roll axis is encoded and accurate forwards and backwards.

The AR-C uses two motors to make a balanced design so even when the system is inverted the side-to-side balance remains constant.

The camera is mounted inside the gearbox effectively, as the main gear surrounds the camera giving maximum control and power.

Also as the camera is also balanced inside the AR-C (via the side to side plate) this creates a very simple and easy to use system.

The ‘boot up’ is very simple—first you power on the 12v circuit, then line up the system, then power up the 24v circuit (powering the motors) and then when happy with the level you want press boot.

There are two motor outputs and a power input.

The base of the rings 1, 2 and or electronics module 3 has mounting holes for various plates, to give various options in mounting. The electronics can also be mounted separately from the rings or anywhere on the rings, including the top.

A difference to a traditional AR system is the new electronics system that is now housed in a single module 3 that can fit onto the AR rings direct, making the AR-C system stand alone, with a single power input. This may also improve the response time. In an example, the response time is less than 20 ms. In another example, the response time is less than 10 ms. In another example, the response time is less than 5 ms. In another example, the response time is less than 1 ms.

The traditional AR has Rings with two motors and a side to side assembly inside a Top Box (motor driver), and also a Control Box (bottom box computer) and a Sensor, all cabled thru the Nexus Sled system.

This is now, in the AR-C, just: AR rings 1, 2 with two motors and a side to side assembly inside (as before) AR-C Control package/module 3.

FIG. 1 is a GC view of the electronics module 3 with the two rings 1, 2 attached - there are also some internal bars for support (not shown in FIG. 1), and the inner dovetail clears the lower box on rotation.

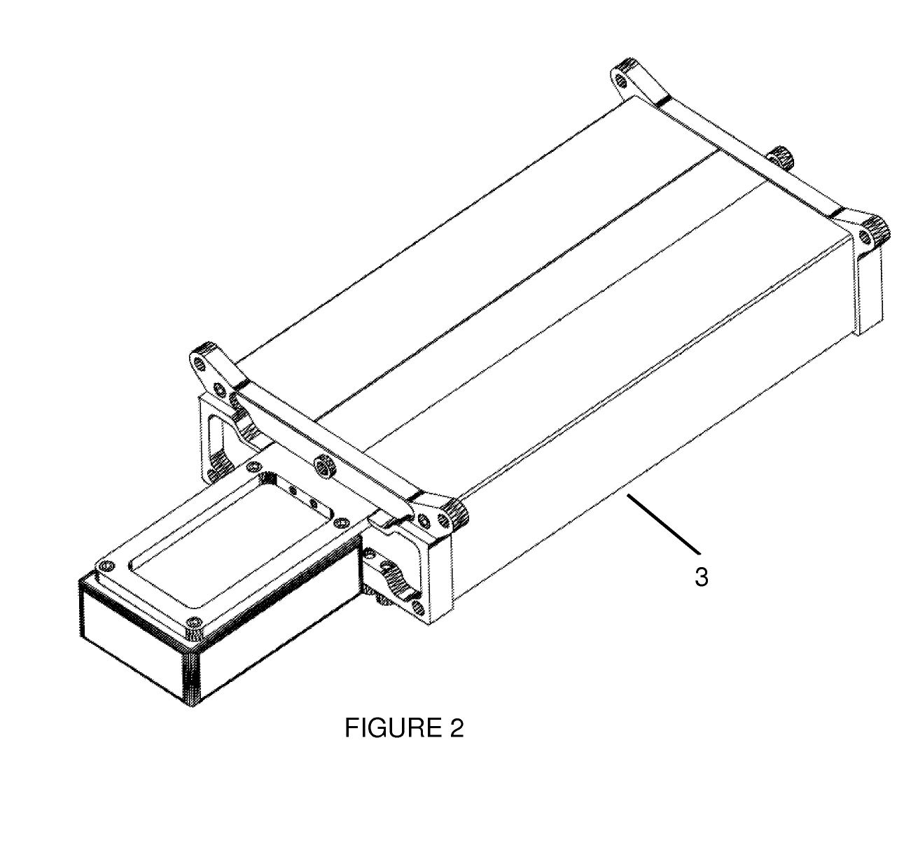

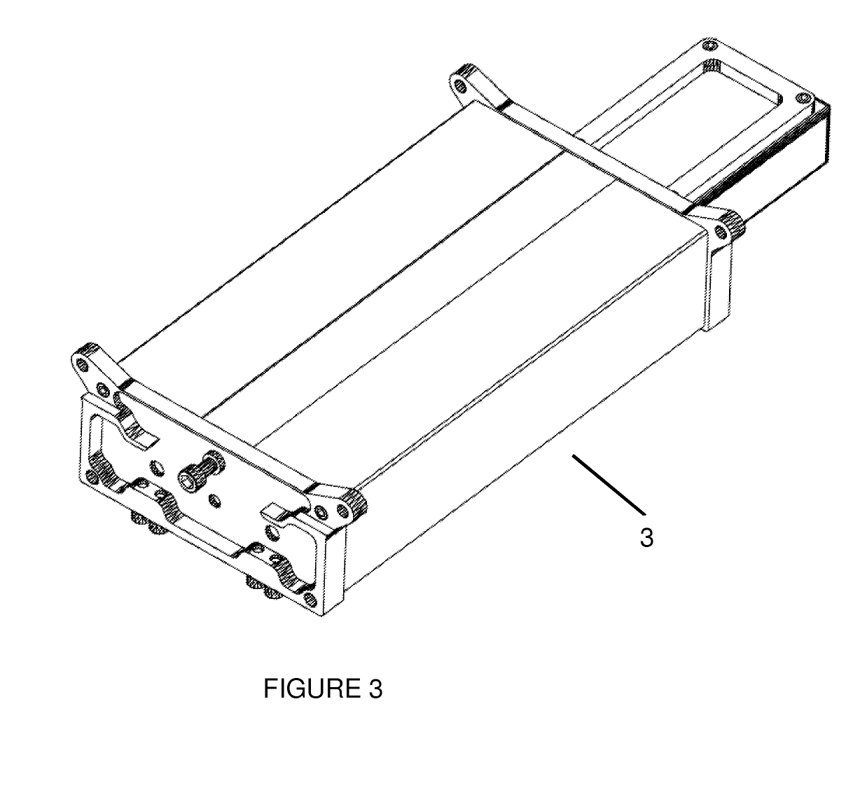

FIGS. 2 and 3 are views of the electronics module 3.

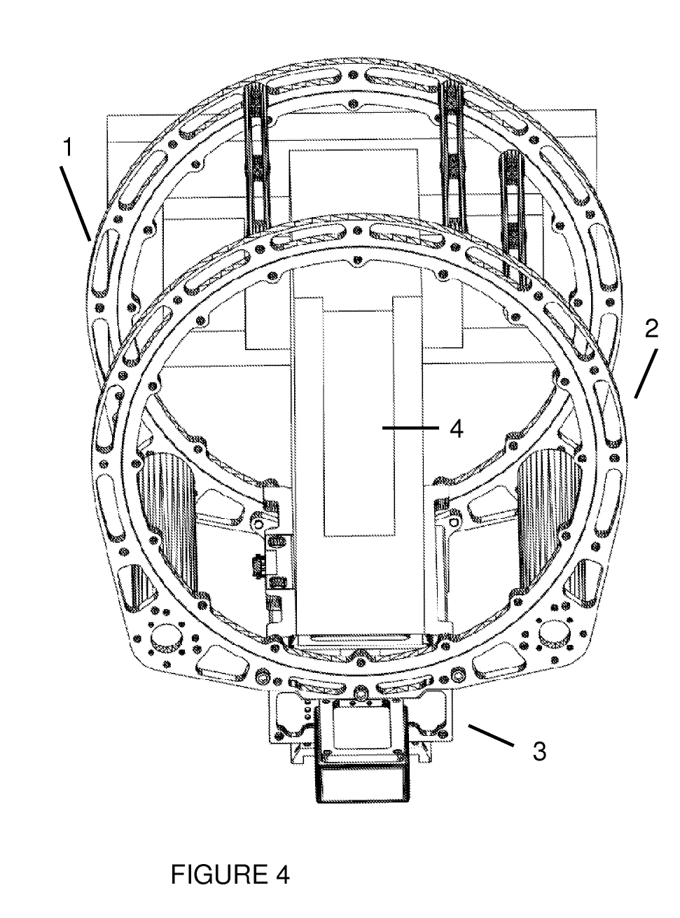

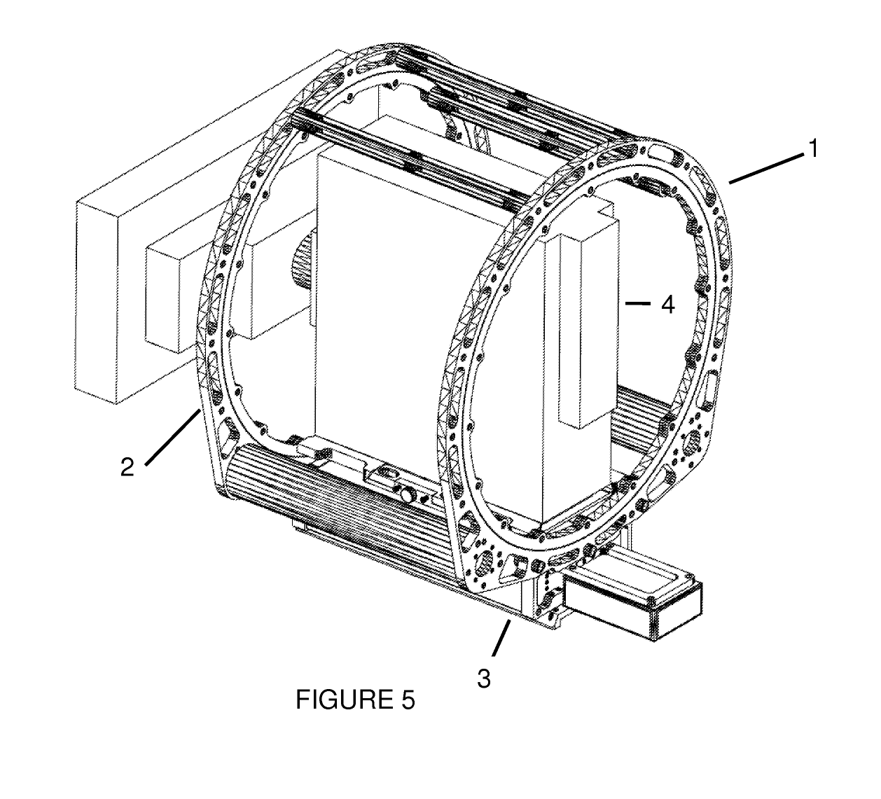

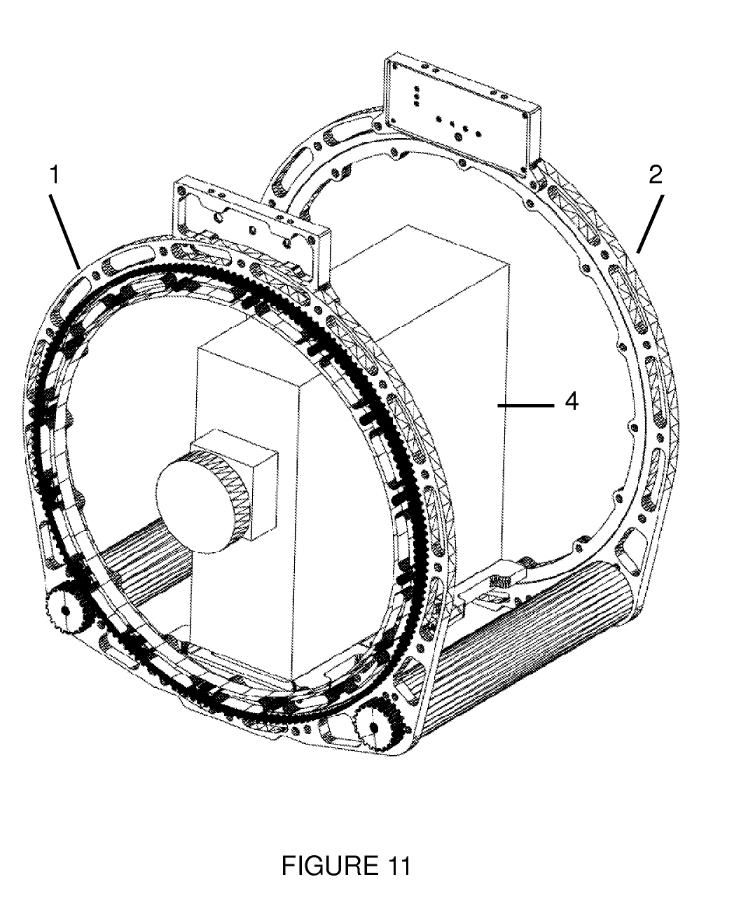

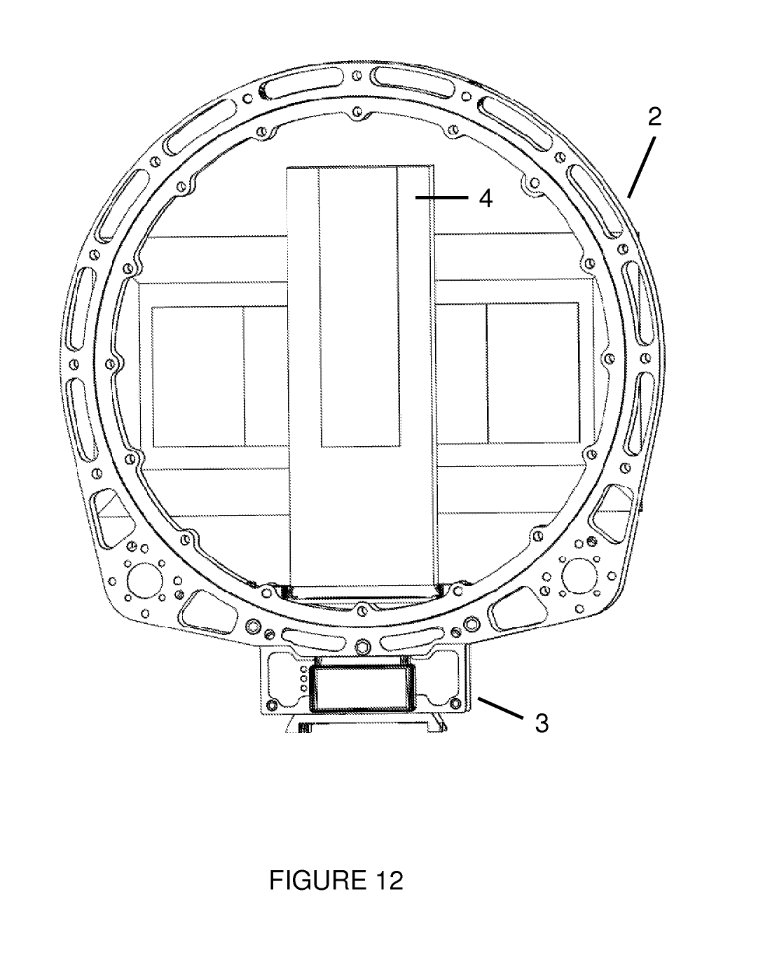

FIGS. 4, 5, 11, and 12 are schematics of the AR-C system, with a camera 4 in position between the two rings.

The camera is balanced side to side, but is bottom heavy inside the rings. So the camera's weight acts as a cam, keeping the centre of gravity in the correct place.

It is possible to balance the camera neutrally to spin the camera on its lens axis when used with the optional horizon override.

Also the rings are designed for maximum clearance and for the lens to be as central as possible on rotation.

It is possible with careful balancing to mount the camera completely nodally on the rotational axis. This means that the axis of rotation is at the centre of the camera image, and the axis of rotation coincides with the optic axis of the lens.

The way the camera sits in the rings is important:

The lens is free out the front and the film magazine is out of the back. The middle is free to allow easy opening of the film door or to program the camera.

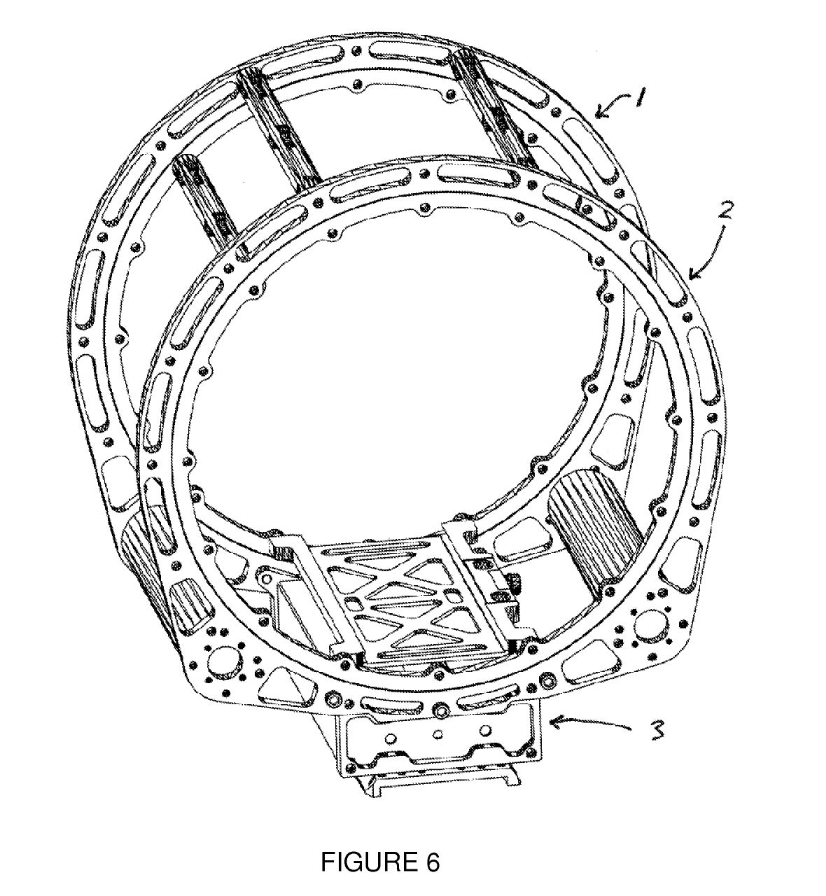

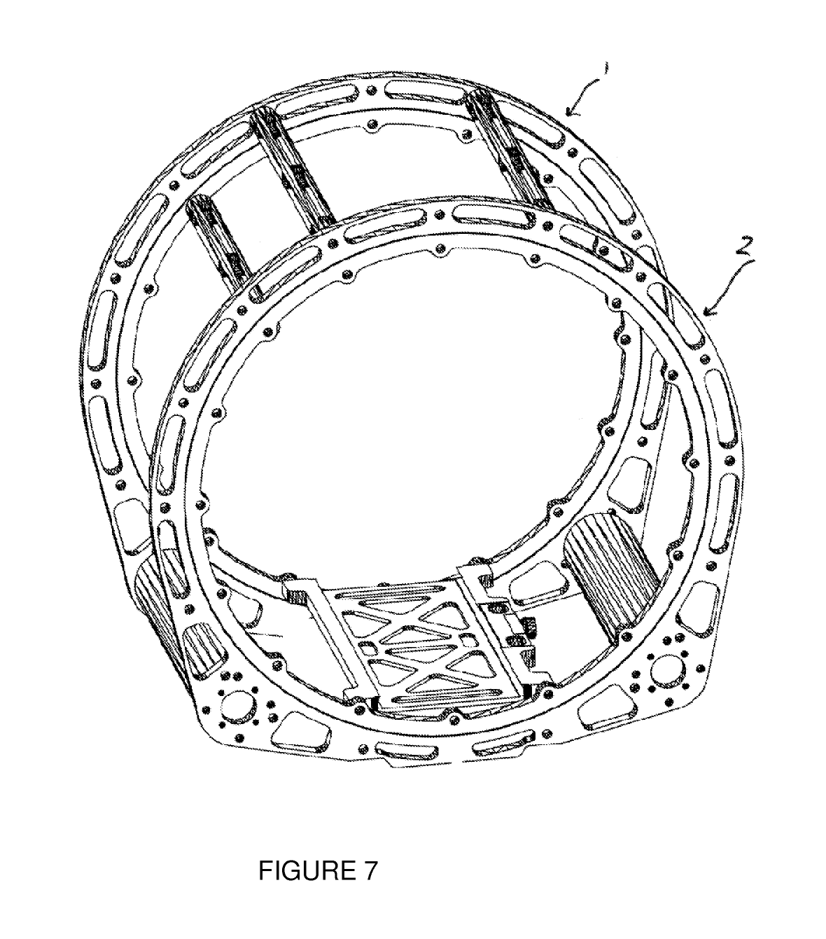

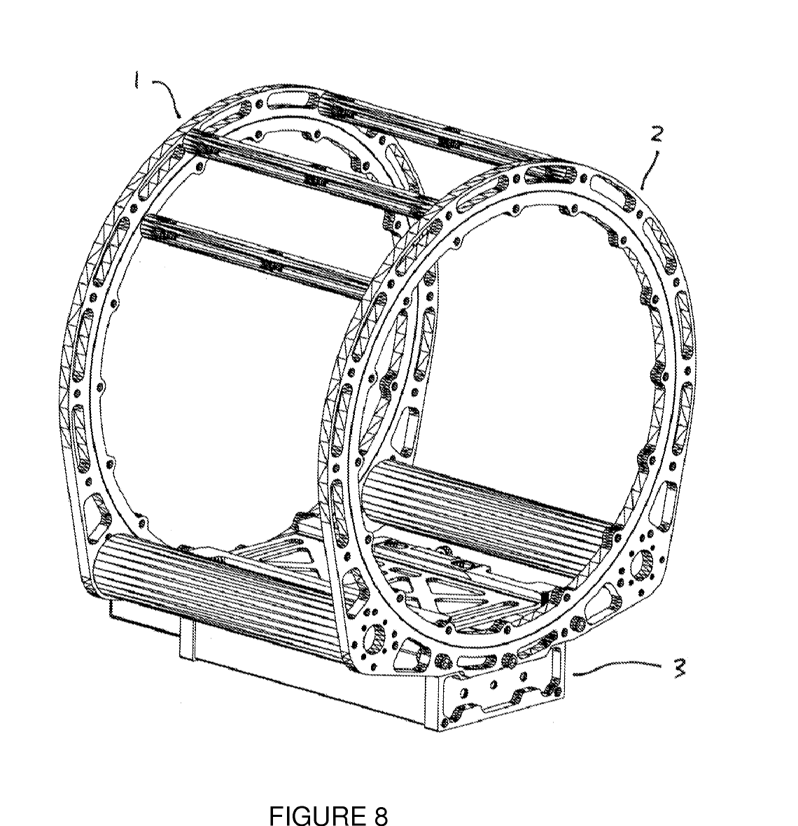

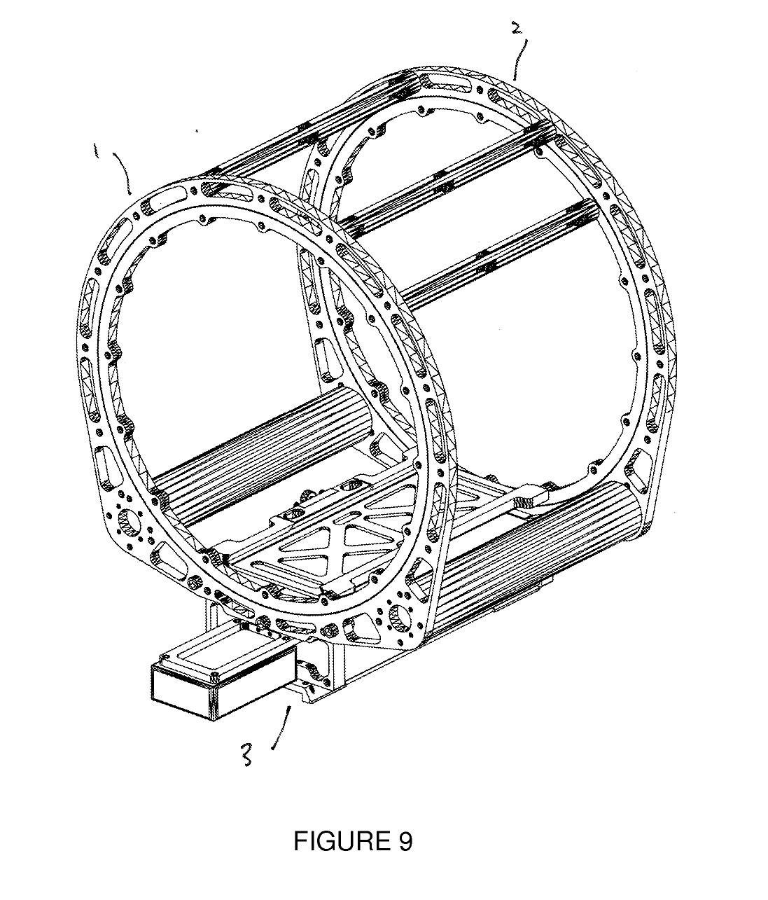

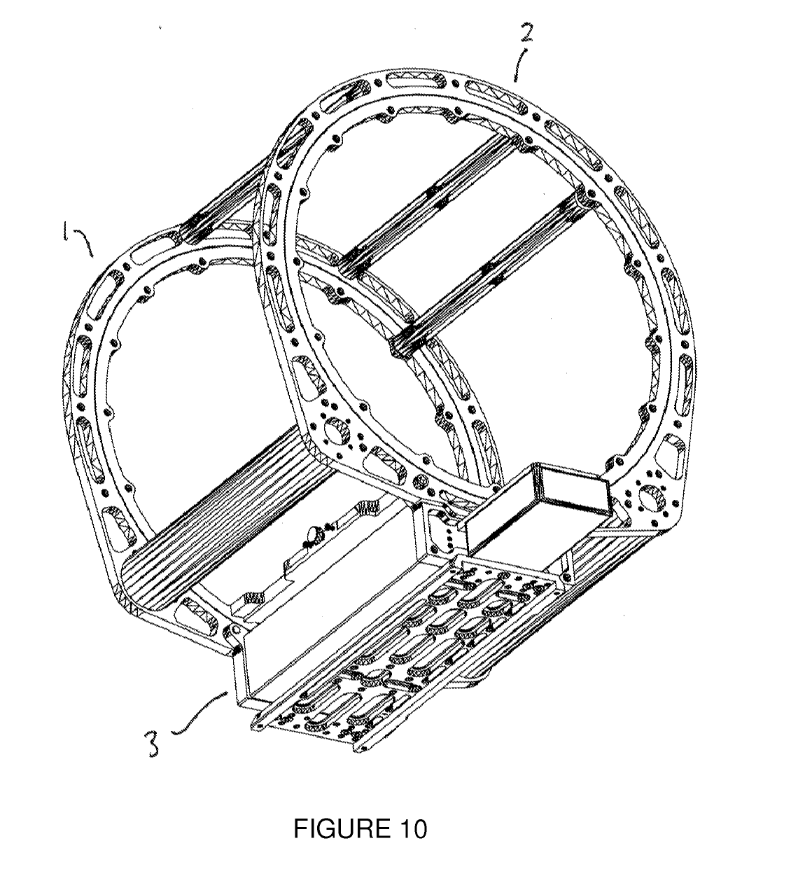

FIGS. 6-10 are drawings showing the rings 1, 2 and module 3 (FIG. 7 omits the module 3).

It is to be understood that the above-referenced arrangements are only illustrative of the application for the principles of the present invention. Numerous modifications and alternative arrangements can be devised without departing from the spirit and scope of the present invention. While the present invention has been shown in the drawings and fully described above with particularity and detail in connection with what is presently deemed to be the most practical and preferred example(s) of the invention, it will be apparent to those of ordinary skill in the art that numerous modifications can be made without departing from the principles and concepts of the invention as set forth herein.

1. Camera stabilization platform system comprising a body, a rotation sensor system in a fixed orientation relative to the body, a motor system and a rotatable member system operable to be rotated by the motor system relative to the body, the rotation sensor system operable to measure a rotation angle and a rotation direction, wherein the motor system is configured to rotate the rotatable member system by the sensed rotation angle in a rotation direction opposite to the sensed rotation direction, characterized in that:
the rotatable member system is operable to perform a full 360 degree rotation relative to the body in less than 1 second.

2. Camera stabilization platform system of claim 1, wherein the rotation sensor system is attached directly to the body.

3. Camera stabilization platform system of claim 1, wherein the rotation sensor system and the body are attached to a rigid system.

4. Camera stabilization platform system of claim 1, wherein the camera stabilization platform system weighs less than 3 kg.

5. Camera stabilization platform system of claim 4, wherein the camera stabilization platform system weighs less than 1 kg.

6. Camera stabilization platform system of claim 1, wherein the camera stabilization platform system is capable of being handheld.

7. Camera stabilization platform system of claim 1, wherein the rotatable member system includes two rings.

8. Camera stabilization platform system of claim 7, wherein the motor system comprises two motors, each motor driving a respective ring.

9. Camera stabilization platform system of claims 7, wherein the camera stabilization platform system is operable to receive a camera between the two rings.

10. Camera stabilization platform system of claim 1, wherein the camera stabilization platform system has a response time less than 20 ms.

11. Camera stabilization platform system of claim 10, wherein the response time is less than 10 ms.

12. Camera stabilization platform system of claim 11, wherein the response time is less than 5 ms.

13. Camera stabilization platform system of claim 12, wherein the response time is less than 1 ms.

14. Camera stabilization platform system of claim 1, wherein the camera stabilization platform system is modular.

15. Camera stabilization platform system of claim 1, wherein the camera stabilization platform system has a form factor of less than 12 inches.

16. Camera stabilization platform system of claim 1, wherein the camera stabilization platform system includes a single electronics module making the camera stabilization platform system stand alone, with a single power input to the single electronics module.

17. Camera stabilization platform system of claim 1, wherein the rotatable member system has a rotational axis, wherein it is possible to mount a camera completely nodally on the rotational axis.
